(19) United States
(12) Patent Application Publication
(10) Pub. No.: US 2013/0164555 A1
(43) Pub. Date: Jun. 27, 2013

(54) SURFACE TREATMENT METHOD FOR ALUMNINUM OR ALUMNINUM ALLOY AND ARTICLE MANUFACTURED BY THE SAME

(71) Applicant: TING DING, Shenzhen City (CN)

(72) Inventor: TING DING, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/566,048

(22) Filed: Aug. 3, 2012

(30) Foreign Application Priority Data
Dec. 23, 2011 (CN) 201110437329.0

(51) Int. Cl. C25D 5/00; B32B 15/04; B32B 3/10

(52) U.S. Cl. 428/596; 205/50; 205/112

(57) ABSTRACT

An article includes an aluminum or aluminum alloy substrate, an anodic layer formed on the substrate, and an electroplating layer formed on the anodic layer. The anodic layer includes a barrier layer formed on the substrate, and a porous layer formed on the barrier layer. The anodic layer defines a plurality of through pores. A method for making the article is also provided.

### BACKGROUND

1. Technical Field

The exemplary disclosure generally relates to a surface treatment method for aluminum or aluminum alloy, and article manufactured by the method.

2. Description of Related Art

Aluminum or aluminum alloy substrates are usually double zincated and chemically nickel plated in that order before electroless plating to improve the bond between aluminum or aluminum alloy substrate and electroless plating layer. However, when corrosion takes place, the zinc layer of the double zincated treatment formed on the aluminum or aluminum alloy substrate will accelerate peeling of the electroless plating layer from the substrate. Furthermore, the double zincating and chemical nickel plating processes are complicated.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary disclosure. Moreover, in the drawings, like reference numerals designate corresponding parts throughout the several views. Wherever possible, the same reference numbers are used throughout the drawings to refer to the same or like elements of an embodiment.

FIG. 1 is a cross-sectional view of a substrate defined with anodic pore.

FIG. 2 is a cross-sectional view of a substrate defined with through pore.

FIG. 3 is a cross-sectional view of an exemplary embodiment of an article.

FIG. 4 is a cross-sectional view of another exemplary embodiment of an article.

### DETAILED DESCRIPTION

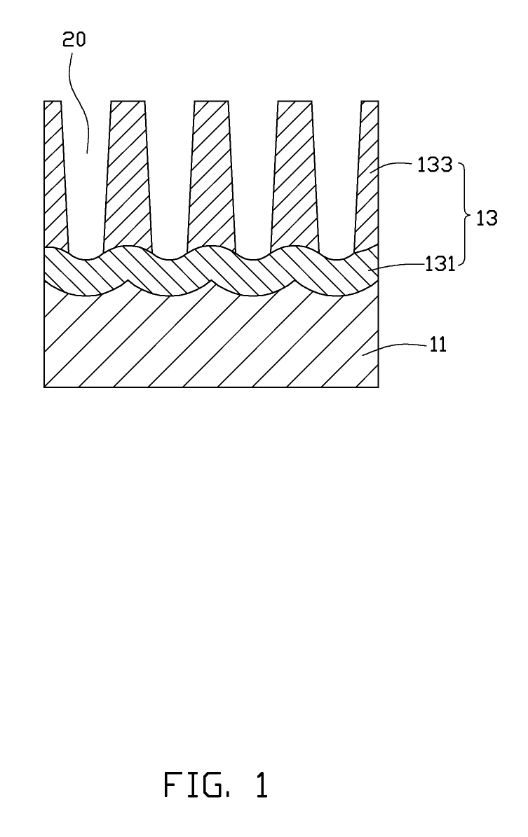

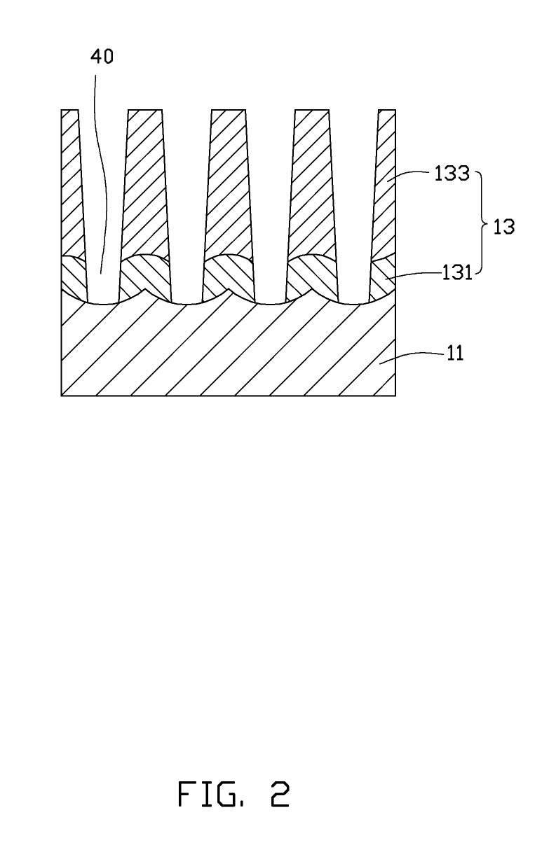

Referring to FIG. 1 and FIG. 2, a surface treatment method for aluminum or aluminum alloy may include at least following steps:

A substrate 11 is provided. The substrate 11 is made of aluminum or aluminum alloy.

The substrate 11 is degreased to remove contaminants, such as grease or dirt. The degreasing process may be carried out by immersing the substrate 11 in a degreasing agent for about 5 minutes (min) to about 8 min. The degreasing agent is maintained at a temperature of about 50° C. to about 60° C. during the degreasing process. In the embodiment, the degreasing agent is a “R105” type degreasing agent provided by Shenzhen Yongbao Chemical Company Limited. Water rinsing is used to remove any remaining degreasing agent from the substrate 11.

The substrate 11 is polished to remove oxide film formed thereon and enhance the glossiness of the substrate 11. The oxide film will have been formed on the substrate 11 when the substrate 11 is exposed to air. The substrate 11 is polished using an aqueous polishing agent for about 10 seconds (s) to about 20 s. The polishing agent contains phosphoric acid having a mass concentration of about 1100˜1300 grams per liter (g/L), and nitric acid having a mass concentration of about 50˜70 g/L. The polishing agent is maintained at a temperature of about 90° C. to about 100° C. during the polishing process.

The substrate 11 is treated using a nitric acid solution to further remove any oxide film that may be residual after the polishing process. The substrate 11 is immersed in the nitric acid solution for 1 min to 2 min. The nitric acid solution is maintained at a room temperature during the treatment. The volume percentage of the nitric solution is about 25% to about 30%.

After being degreased, polished, and treated with the nitric acid solution and then again rinsed in water, the surface of the substrate 11 is roughened.

An anodic layer 13 is formed on the substrate 11 by anodizing. The anodizing process may be carried out using an aqueous anodizing electrolyte for about 10 min to about 15 min. The electrolyte contains sulfuric acid having a mass concentration of about 100-150 g/L, phosphoric acid having a mass concentration of about 200-250 g/L, and ethylenediaminetetraacetic acid (EDTA) having a mass concentration of about 1-3 g/L. The anodizing electrolyte is maintained at a temperature of about 25° C. to about 30° C. during the anodizing process. The anodizing current density is about 0.8 A/dm² to about 1.2 A/dm². The anodizing voltage is about 20 volts (V) to about 25 V. The anodic layer 13 has a thickness of about 10 micrometer (μm) to about 15 μm.

The anodic layer 13 includes a barrier layer 131 formed on the substrate 11, and a porous layer 133 formed on the barrier layer 131. The porous layer 133 defines a plurality of anodic pores 20 therein.

During the anodizing process, the EDTA, which acts as a complexing agent contained in the electrolyte, reacts with aluminum ions of the substrate 11 to form aluminum complex compound at the start. The aluminum complex compound is prone to dissolving in the anodizing electrolyte, thus the aluminum complex compound does not obstruct the formation of the barrier layer 131. Inherent in the anodizing process, the oxygen evolution reaction at the bottom portions of the anodic pores 20 near the barrier layer 131 intensifies and generates many more hydrogen ions in the anodizing electrolyte. The increase of the hydrogen ions gives the anodizing electrolyte a strong acidity. In the anodizing electrolyte which has a strong acidity, the aluminum complex compound stabilizes. The aluminum complex compound then prevents the formation of the barrier layer 131. While, as a balance in an electrochemical reaction, a portion of the barrier layer 131 will dissolve in the anodizing electrolyte along with the formation of barrier layer 131. When the formation of the barrier layer 131 is obstructed, the barrier layer 131 located between the anodic pores 20 and the substrate 11 gradually dissolves. As a result, a plurality of through pores 40 are defined and connect the anodic pores 20.

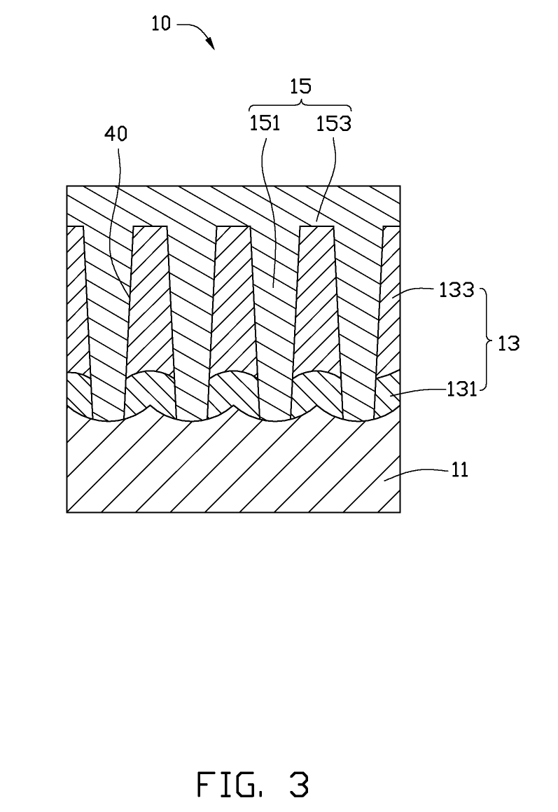

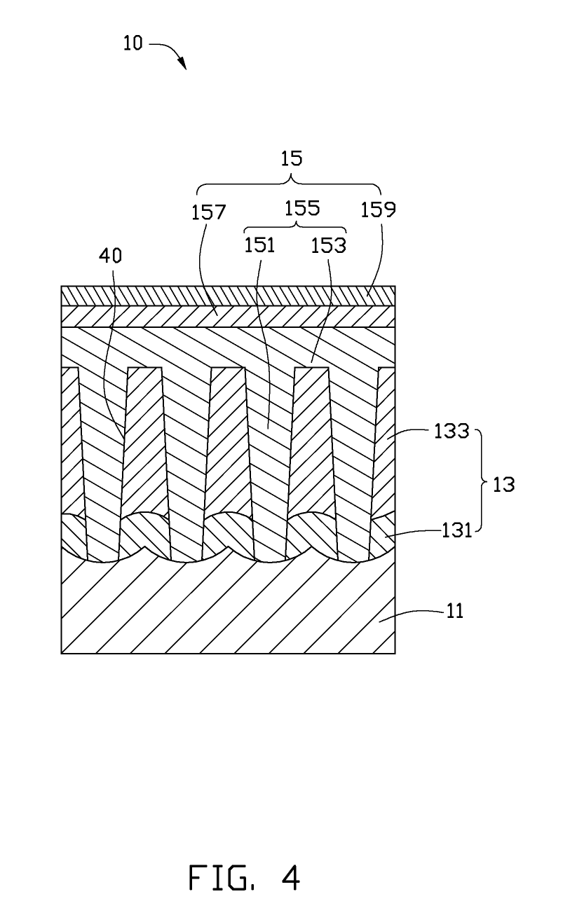

Referring to FIG. 3, An electroplating layer 15 is formed on the anodic layer 13 by electroplating. The electroplating layer 15 is made of metal with high corrosion resistance. The electroplating layer 15 includes a plurality of filling portions 151 and a covering portion 153. The filling portions 151 fill the anodic pores 20 and the through pores 40. The covering portion 153 is formed on the anodic layer 13 and the filling portions 151. The electroplating layer 15 may be made of nickel or chromium. Alternatively, the electroplating layer 15 may be a multiplicity of layers which includes a copper layer 155, a nickel layer 157 and a chromium layer 159 formed on the anodic layer 13 in that order (shown in FIG. 4). The copper layer 155 includes a plurality of filling portions 151 and a covering portion 153. The filling portions 151 fill the anodic pores 20 and the through pores 40.

During the electroplating process, to prevent the anodic layer 13 from dissolving, the electroplating solutions used in forming the electroplating layer 15 are neutral or weakly acidic. When at a high temperature, Al₂O₃ of the anodic layer 13 would generate Al₂O₃.3H₂O which would expand the anodic layer 13 to seal the through pores 40. Therefore, the temperature of the electroplating solution is kept at less than 70° C., thereby the through pores 40 can be prevented from sealing.

In the embodiment, the anodizing process may last for about 10 min to 15 min When the anodizing time is longer than 15 min, the anodic layer 13 formed on the substrate 11 becomes too thick and the volume of the anodic pores 20 and through pores 40 greatly increase, resulting in a lengthy electroplating process to fill the through pores 40 and cover the anodic layer 13. When the anodizing time is less than 10 min, the anodic layer 13 formed on the substrate 11 becomes too thin, causing a poor bond between the electroplating layer 15 and the substrate 11.

The filling portions 151 provide the electroplating layer 15 a secure bond to the substrate 11. The filling portions 151 can also prevent corrosive agents from entering the substrate 11, thus improving the corrosion resistance of the substrate 11. The surface treatment method for aluminum or aluminum alloy is also very simple.

An exemplary embodiment of an article 10 created by the method includes a substrate 11 and an anodic layer 13 formed on the substrate 11.

The substrate 11 is made of aluminum or aluminum alloy.

The anodic layer 13 includes a barrier layer 131 formed on the substrate 11, and a porous layer 133 formed on the barrier layer 131. The anodic layer 13 has a thickness of about 10 μm to about 15 μm. The anodic layer 13 defines a plurality of through pores 40.

The article 10 further includes an electroplating layer 15. The electroplating layer 15 includes a plurality of filling portions 151 and a covering portion 153. The filling portions 151 fill the anodic pores 20 and the through pores 40. The covering portion 153 is formed on the anodic layer 13 and the filling portions 151. The electroplating layer 15 is made of metal with high corrosion resistance. The electroplating layer 15 may be made of nickel or chromium. The electroplating layer 15 may be a multiplicity of layers which includes a copper layer 155, a nickel layer 157 and a chromium layer 159 formed on the anodic layer 13 in that order.

The article 10 has a high wear resistance and high corrosion resistance.

### EXAMPLE 1

A substrate 11 was provided. The substrate 11 was made of “6061-T6” type aluminum alloy.

The substrate 11 was degreased by immersing the substrate 11 in a degreasing agent for about 6 min. The degreasing agent was maintained at a temperature of about 60° C. during the degreasing process. The degreasing agent was a “R105” type degreasing agent provided by Shenzhen Yongbao Chemical Company Limited.

The substrate 11 was polished using an aqueous polishing agent for about 13 seconds. The polishing agent contained phosphoric acid having a mass concentration of about 1200 g/L, and nitric acid having a mass concentration of about 60 g/L The polishing agent was maintained at a temperature of about 95° C. during the polishing process.

The substrate 11 was immersed in a nitric acid solution for 1.5 min. The nitric acid solution was maintained at room temperature during the nitric acid solution treatment. The volume percentage of the nitric solution was about 30%.

An anodic layer 13 was formed on the substrate 11 by anodizing. The anodizing process was carried out using an aqueous anodizing electrolyte for about 12 min. The electrolyte contained sulfuric acid having a mass concentration of about 120 g/L, phosphoric acid having a mass concentration of about 240 g/L, and EDTA having a mass concentration of about 2 g/L. The electrolyte was maintained at a temperature of about 28° C. during the anodizing process. The anodizing current density was about 1.0 A/dm². The anodizing voltage was about 24 V.

An electroplating layer 15 was formed on the substrate 11 by electroplating. The electroplating layer 15 included a copper layer 155, a nickel layer 157, and a chromium layer 159 formed on the anodic layer 13 in that order.

Forming the copper layer 155 of the electroplating layer 15: the substrate 11 was immersed in a first aqueous electrolyte for about 15 min. The first aqueous electrolyte contained cupric sulfate having a mass concentration of about 80 g/L, potassium tartrate having a mass concentration of about 8 g/L, and 1-hydroxy ethylidene-1,1-diphosphonic acid (HEDP) having a mass concentration of about 150 g/L. The electrolyte was maintained at a temperature of about 40° C. during the electroplating process. The electroplating current density was about 3.0 A/dm².

Forming the nickel layer 157 of the electroplating layer 15: the substrate 11 was immersed in a second aqueous electrolyte for about 10 min. The second aqueous electrolyte contained nickelous sulfate having a mass concentration of about 280 g/L, nickelous chloride having a mass concentration of about 55 g/L, and boric acid having a mass concentration of about 50 g/L. The second aqueous electrolyte was maintained at a temperature of about 55° C. during the forming of the nickel layer 157. The electroplating current density was about 10 A/dm².

Forming the chromium layer 159 of the electroplating layer 15: the substrate 11 was immersed in a third aqueous electrolyte for about 30 min. The third aqueous electrolyte contained chromic acid having a mass concentration of about 250 g/L and sulphuric chloride having a mass concentration of about 1.2 g/L. The third aqueous electrolyte was maintained at a temperature of about 35° C. during the forming of the chromium layer 159. The electroplating current density was about 10 A/dm².

### COMPARISON EXAMPLE

Unlike example 1, the anodizing electrolyte used to form the anodic layer 13 in the comparison example contained no EDTA. Excepting the above difference, the remaining experiment conditions of the comparison example were the same as in example 1.

### RESULTS OF THE EXAMPLES

Chemicals resistance test and wear resistance test were performed on the coatings of example 1 and the comparison example.

Chemical resistance testing was carried out as follows. The articles were coated with chemicals and left standing for about 24 hours, then the chemicals were removed from the surface of the articles. The chemicals were selected from a group consisting of hand cream, sunscreen, lipstick, foundation cream, insecticide and petrol. The chemicals are listed in Table 1, as below.

TABLE 1

| chemicals | brand | type |
|---|---|---|
| hand cream | Nivea whitening hydration | 84663 |
| | hand cream | |
| sunscreen | Nivea firming sun lotion | 85656 |
| lipstick | Bleunuit | 07-XK-0003 |
| foundation | Olay whitening track-free | OB-2 |
| cream | liquid foundation | |
| insecticide | Teho Hyttysgeeli | 64003740 |
| petrol | Zippo Lighterfluid | PA16701 |

The tests showed no discoloration, no pitting corrosion, and no peeling occurring on the coatings of example 1. Peeling of the electroplating layer was found in the coating in the comparison example. That is, the coatings of example 1 had better chemical resistance than that of the coatings of the comparison example.

Wear resistance test was carried out as follows. The samples manufactured by the example 1 and the comparison example were tested using an “R180/530TE30” type trough vibrator made by Rosier Company. “RKS10K” type yellow cone abrasive, “RKK15P” type green pyramid abrasive, and “FC120” type detergent were held in the trough vibrator. The volume ratio of the “RKS 10K” type yellow cone abrasive and the “RKK15P” type green pyramid abrasive was 3:1. The “RKS10K” type yellow cone abrasive and the “RKK15P” type green pyramid abrasive were made by Rosier Company.

The tests showed no peeling occurring on coatings of example 1, and showed a few scratches on the electroplating layer 15 of example 1. Peeling of the electroplating layer was found in the coatings in the comparison example. That is, the coatings of example 1 had better wear resistance than that of the coatings of comparison example.

It is to be understood, however, that even through numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An article, comprising:
an aluminum or aluminum alloy substrate,
an anodic layer formed on the substrate, the anodic layer comprising a barrier layer formed on the substrate, and a porous layer formed on the barrier layer, the anodic layer defining a plurality of through pores; and
an electroplating layer formed on the anodic layer.

2. The article as claimed in claim 1, wherein the anodic layer has a thickness of about 10 μm to about 15 μm.

3. The article as claimed in claim 1, wherein the electroplating layer comprises a plurality of filling portions and a covering portion, the filling portions fill the through pores, the covering portion is formed on the anodic layer and the filling portions.

4. The article as claimed in claim 3, wherein the electroplating layer is made of metal with high corrosion resistance.

5. The article as claimed in claim 4, wherein the electroplating layer is made of nickel or chromium.

6. The article as claimed in claim 4, wherein the electroplating layer is a multiplicity of layers which includes a copper layer, a nickel layer and a chromium layer.

7. A surface treatment method, comprising:
providing an aluminum or aluminum alloy substrate;
forming an anodic layer on the substrate by anodizing, the anodizing process being carried out using an aqueous anodizing electrolyte containing sulfuric acid, phosphoric acid, and ethylenediaminetetraacetic acid, the anodic layer comprising a barrier layer formed on the substrate, and a porous layer formed on the barrier layer, the anodic layer defining a plurality of through pores; and
forming an electroplating layer on the anodic layer.

8. The surface treatment method as claimed in claim 7, wherein the anodizing electrolyte contains sulfuric acid having a mass concentration of about 100-150 g/L, phosphoric acid having a mass concentration of about 200-250 g/L, and ethylenediaminetetraacetic acid having a mass concentration of about 1-3 g/L.

9. The surface treatment method as claimed in claim 8, wherein during the anodizing process, the anodizing electrolyte is maintained at a temperature of about 25° C. to about 30° C., anodizing current density is about 0.8 A/dm² to about 1.2 A/dm², anodizing voltage is about 20 V to about 25 V, the anodizing electrolyte is maintained at a temperature of about 25° C. to about 30° C.

10. The surface treatment method as claimed in claim 9, wherein the anodizing process is about 10 min to about 15 min.

11. The surface treatment method as claimed in claim 7, wherein before forming the anodic layer, the substrate is degreased, polished, and treated with the nitric acid solution.

12. The surface treatment method as claimed in claim 11, wherein the substrate is polished using an aqueous polishing agent containing phosphoric acid and nitric acid for about 10 s to about 20 s.

13. The surface treatment method as claimed in claim 12, wherein the aqueous polishing agent contains phosphoric acid having a mass concentration of about 1100˜1300 g/L, and nitric acid having a mass concentration of about 50˜70 g/L.

14. The surface treatment method as claimed in claim 13, wherein during the polishing process, the polishing agent is maintained at a temperature of about 90° C. to about 100° C.

15. The surface treatment method as claimed in claim 11, wherein the substrate is immersed in the nitric acid solution for 1 min to 2 min.

16. The surface treatment method as claimed in claim 15, wherein the nitric acid solution is maintained at a room temperature.

17. The surface treatment method as claimed in claim 15, wherein volume percentage of the nitric solution is about 25% to about 30%.
